(19) United States
(12) Patent Application Publication
(10) Pub. No.: US 2025/0085592 A1
(43) Pub. Date: Mar. 13, 2025

(54) HIGH-CONTRAST LASER-ILLUMINATED LIQUID CRYSTAL ON SILICON DISPLAY

(71) Applicant: Meta Platforms Technologies, LLC, Menlo Park, CA (US)

(72) Inventors: Zhujun Shi, Redmond, WA (US); Min Chul Shin, Bellevue, WA (US); Guohua Wei, Redmond, WA (US); Giuseppe Calafiore, Woodinville, WA (US)

(21) Appl. No.: 18/826,044

(22) Filed: Sep. 5, 2024

Related U.S. Application Data
(60) Provisional application No. 63/581,343, filed on Sep. 8, 2023.

(51) Int. Cl. G02F 1/13357

(52) U.S. Cl. CPC G02F 1/133615; G02F 2201/307; G02F 2202/30

(57) ABSTRACT

The disclosed method may include configuring an illuminator to emit a first path of light in a first direction and to emit a second path of light in a second direction. The method may additionally include, configuring a reflector to reflect the first path of light in the second direction. The method may also include configuring the first path of light reflected in the second direction to interfere destructively with the second path of light when a liquid crystal is set to an off state. Various other methods, systems, and computer-readable media are also disclosed.

### CROSS REFERENCE TO RELATED APPLICATION

This application claims the benefit of U.S. Provisional Application No. 63/581,343, filed Sep. 8, 2023, the disclosures of each of which are incorporated, in their entirety, by this reference.

### BRIEF DESCRIPTION OF DRAWINGS

The accompanying drawings illustrate a number of exemplary embodiments and are a part of the specification. Together with the following description, these appendices demonstrate and explain various principles of the present disclosure.

FIG. 1 illustrates an example laser-based panel display.

FIG. 2 illustrates an example laser illuminator for a laser-based panel display.

FIG. 3 illustrates an example illumination system for a liquid crystal on silicon display.

FIG. 4 illustrates example outcomes in the contrast of a liquid crystal on silicon display under different scenarios.

FIG. 5 illustrates an example illumination system with a meta-reflector.

FIG. 6 illustrates an example illumination system with a chirped distributed Bragg reflector.

FIG. 7 illustrates an example illumination system with meta-reflectors separately interacting with red, green, and blue light.

FIG. 8 illustrates an example illumination system with chirped distributed Bragg reflectors separately interacting with red, green, and blue light.

FIG. 9 illustrates a flow diagram of an example method for configuring a laser-illuminated display.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The present application is generally directed to high-contrast laser-illuminated displays. In particular, liquid crystal on silicon (LCoS) panels may experience light leakage via the polarizer element (e.g., due to some off-normal incidence of light at the polarizer). This light leakage may substantially lower contrast. Various systems and devices described herein may introduce phase delays to light that is reflected back to the polarizer such that there is destructive interference between reflected light that would leak via the polarizer and non-reflected light that would leak via the polarizer. Systems and devices described herein may implement various techniques for introducing the appropriate phase delay for each wavelength (e.g., red, green, and blue light). In one example, the reflector may include a meta-reflector with anomalous dispersion, resulting in reflected rays of each wavelength having a phase delay for that wavelength that will result in destructive interference. In another example, the reflector may include a chirped distributed Bragg reflector (DBR) that selectively reflects different wavelengths at different pitches, resulting in a phase delay for each wavelength that causes destructive interference. Because the destructive interference may be substantial (e.g., approximately complete) relative to leaked light, but insignificant compared to signal light, the destructive interference may dramatically improve the contrast ratio of the display.

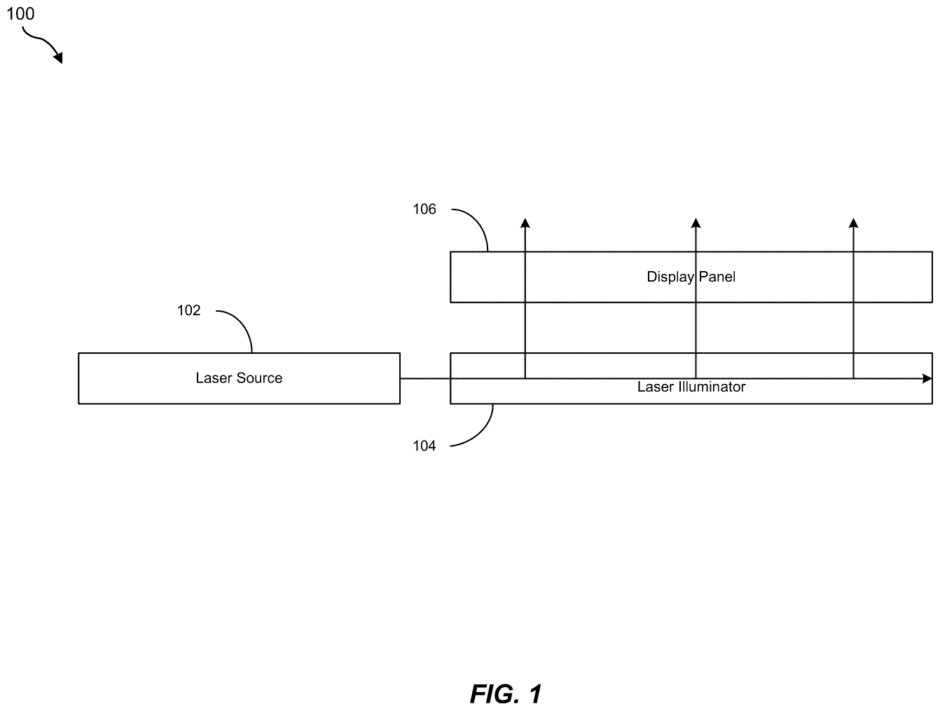

FIG. 1 illustrates an example laser-based panel display 100. As shown in FIG. 1, laser-based panel display 100 may include a laser source 102, a laser illuminator 104, and a display panel 106. Laser source 102 may generate coherent light. In some examples, laser source 102 may include multiple lasers (e.g., red, green, and blue) to produce a full-color image. In general, laser source 102 may include any coherent light source. Laser illuminator 104 may direct and distribute light onto display panel 106. In some examples, laser illuminator 104 may include a photonic integrated circuit (PIC). Display panel 106 may include any panel suitable for laser illumination, including, without limitation, a liquid crystal display (LCD), a liquid crystal on silicon (LCoS) display, a grating light valve (GLV) display, and a digital light processing (DLP) display.

In some examples, absent the device configurations described herein resulting in destructive interference to reduce or eliminate light leakage, the contrast ratio (CR) of display 100 may be determined by the polarization extinction ratio (PER) of light emitted from laser illuminator 104 and the polarization conversion efficiency (η) of display panel 106. Thus, for example, the contrast ratio may be described by the equation CR=PER×η.

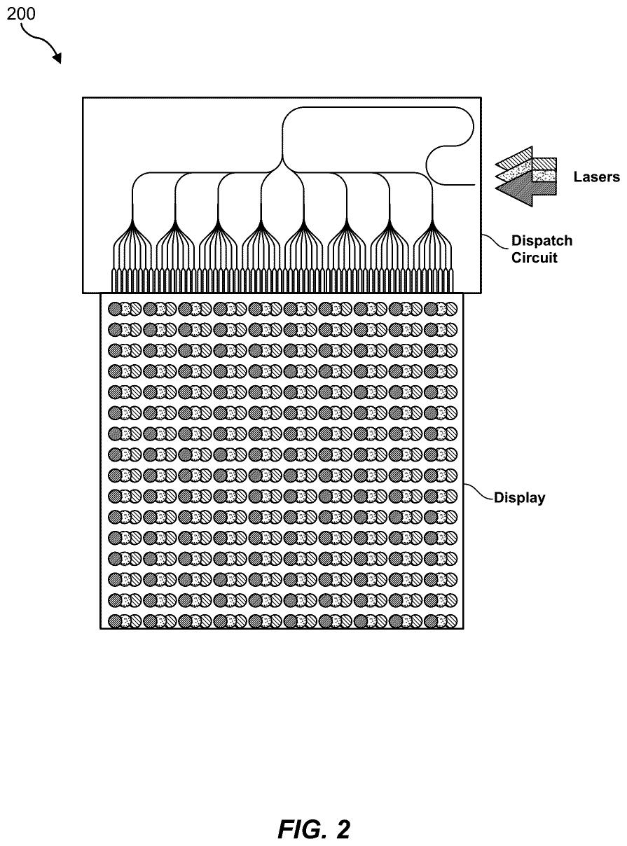

FIG. 2 illustrates an example laser illuminator for a laser-based panel display 200. In some examples, laser-based panel display 200 may include a laser illuminator that corresponds to laser illuminator 104 of FIG. 1.

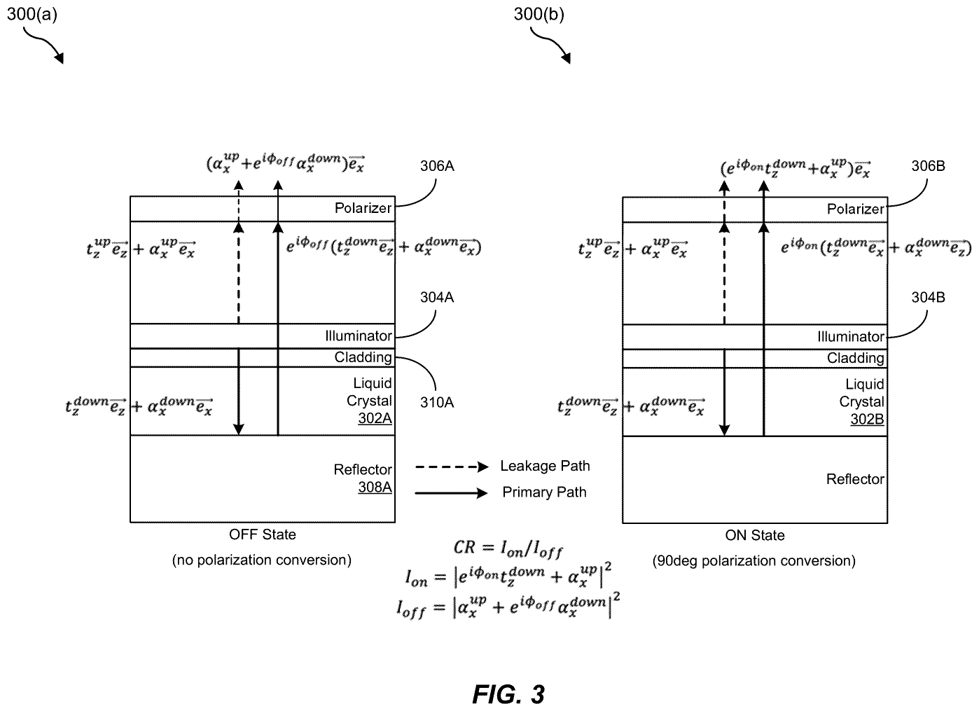

FIG. 3 illustrates an example illumination system for a liquid crystal on silicon display in a state 300(a) and in a state 300(b). In state 300(a), a liquid crystal 302A may be in an off state, resulting in no polarization conversion. In state 300(b), the liquid crystal 302B may be in an on state, resulting in a 90 degree polarization conversion.

The illumination system may include an illuminator 304A and 304B (e.g., a photonic integrated circuit). The illuminator 304A and 304B may emit light both upwards and downwards. The light emitted downwards may pass through the liquid crystal 302A and 302B and be reflected back upwards. When the liquid crystal 302B is in the on state, the light reflected back upwards may be modulated such that the modulated light passes through the polarizer 306B (e.g., can be seen as part of an image). When the liquid crystal 302A is in the off state, the reflected light may generally be blocked at the polarizer 306A. However, because the reflected light may be incident at the polarizer 306A at an oblique angle (e.g., rather than at a perfectly normal angle), some of the reflected light in off state 300(a) may nevertheless leak through the polarizer 306A. Likewise, some of the light on the upward path from the illuminator 304A and 304B may pass through the polarizer 306A and 306B (in both off state 300(a) and on state 300(b)).

In order to reduce the intensity of light passing through the polarizer 306A in off state 300(a), the systems and devices described herein may be configured such that, in off state 300(a), the light emitted upward from the illuminator 304A and the light emitted downward from the illuminator 304A destructively interfere (e.g., minimizing I_{off}). For example, these systems and devices may be configured to control the relative phase delay of the two light paths such that destructive interference results. The systems and devices may be configured to control the relative phase delay of the two light paths using any of a variety of approaches. For example, these systems and devices may be configured to control the relative phase delay of the two light paths through engineering of length of the light path between the illuminator 304A and the reflector 308A (e.g., by engineering the distance between the illuminator 304A and the reflector 308A to be such that, once light traveling that path has been reflected and reaches the illuminator 304A again, it is out of phase with light emitted upwards from the illuminator 304A, such that there will be destructive interference between the two paths. Engineering the length of the path may be accomplished in any suitable manner. For example, the thickness of a cladding 310A between the illuminator 304A and the liquid crystal 302A may be selected to result in a light path length that results in destructive interference between light emitted upwards from the illuminator 304A and light emitted downwards from the illuminator 304B. In another example, the index of the liquid crystal material may be selected to result in a light path that results in destructive interference.

As will be explained in greater detail below, reducing the intensity of leaked light in state 300(a), the systems and methods described herein may significantly increase the contrast ratio of a laser-illuminated display.

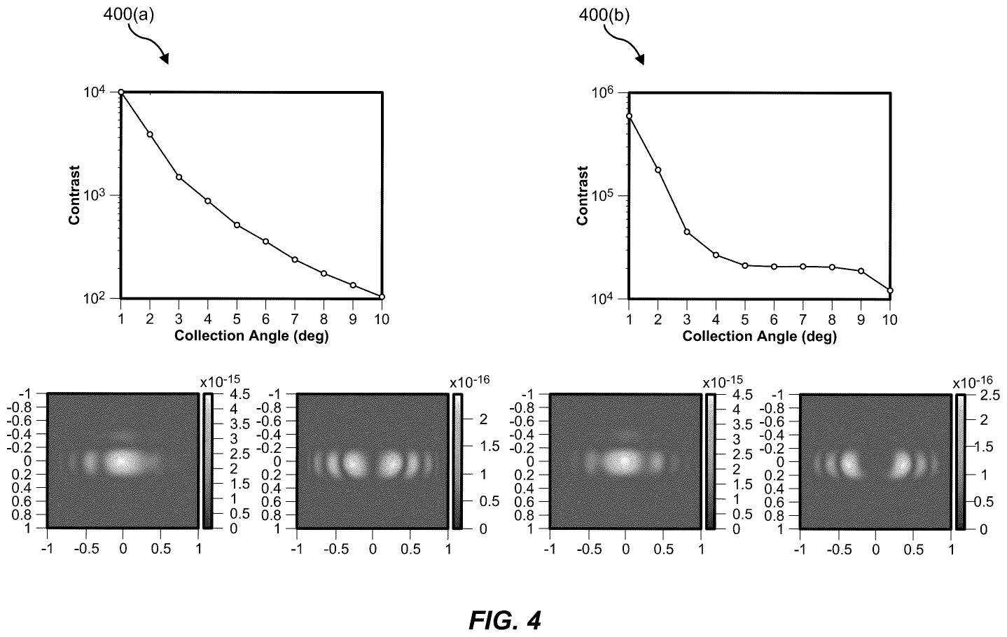

FIG. 4 illustrates example outcomes in the contrast of a liquid crystal on silicon display under different scenarios. An outcome 400(a) shows the contrast ratio of a laser-illuminated display as a function of far field polar angle without applying the leakage path engineering techniques described above. An outcome 400(b) shows the contrast ratio of a laser-illuminated display as a function of far field polar angle with the application of the leakage path engineering techniques described above. As can be seen in FIG. 4, in some cases the leakage path engineering techniques described above can increase the contrast approximately by a factor of 100.

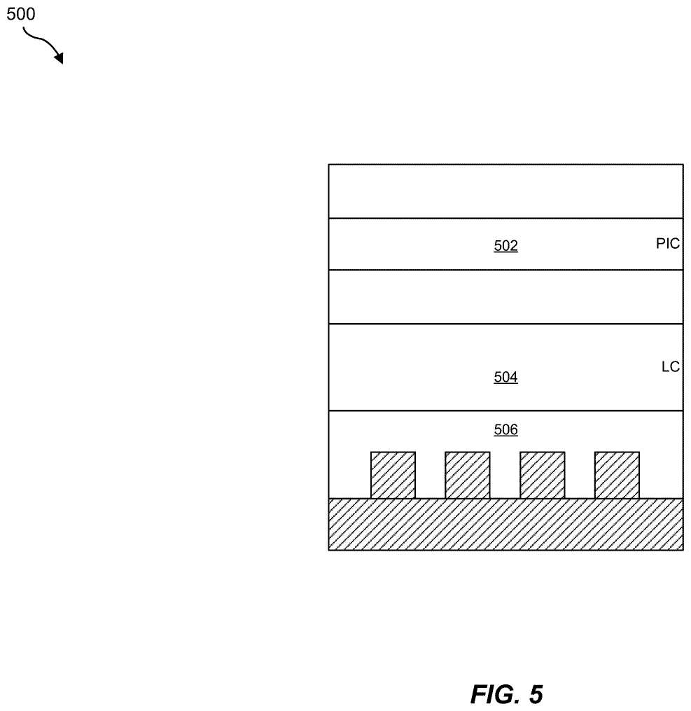

FIG. 5 illustrates an example illumination system 500 with a meta-reflector. As shown in FIG. 5, illumination system 500 may include a photonic integrated circuit 502, a liquid crystal 504, and a meta-reflector 506. As described earlier, the interference between the leakage path (i.e., the path of light emitted upward from the illuminator, such as photonic integrated circuit 502) and the primary path (i.e., the path of light emitted downward from the illuminator) may be controlled by designing the cladding thickness and/or the liquid crystal material index such that ϕ_{off}=(2n+1)π. However, depending on the application, the laser source bandwidth may range from <0.1 nm to ^{˜}10 nm. In the case where the bandwidth is relatively large, the systems and devices described herein may be further engineered to maintain the destructive interference condition over the spectral bandwidth. In one example, these systems and methods may be engineered with a meta-reflector 506 to provide anomalous dispersion, such that destructive interference is maintained across the spectral bandwidth.

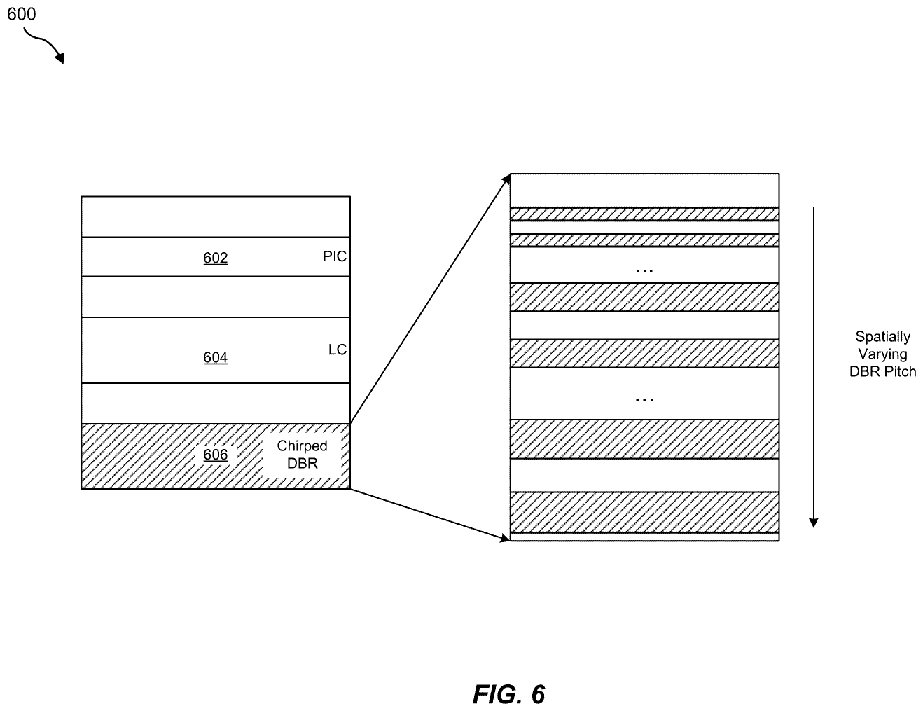

FIG. 6 illustrates an example illumination system 600 with a chirped distributed Bragg reflector. As shown in FIG. 6, illumination system 600 may include a photonic integrated circuit 602, a liquid crystal 604, and a chirped distributed Bragg reflector 606. The spatially varying pitch of the distributed Bragg reflector 606 may tune the effective optical path length for different wavelengths, such that destructive interference is maintained across the spectral bandwidth.

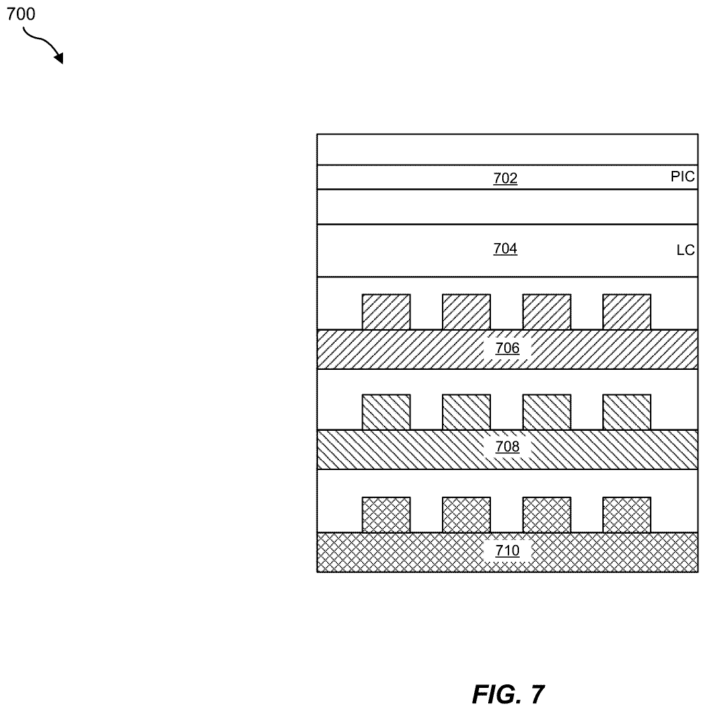

FIG. 7 illustrates an example illumination system 700 with meta-reflectors separately interacting with red, green, and blue light. As shown in FIG. 7, illumination system 700 may include a photonic integrated circuit 702, a liquid crystal 704, a meta-reflector 706 for blue light, a meta-reflector 708 for green light, and a meta-reflector 710 for red light. Meta-reflectors 706, 708, and 710 may be placed at different layers to reflect achromatically at red, green, and blue light.

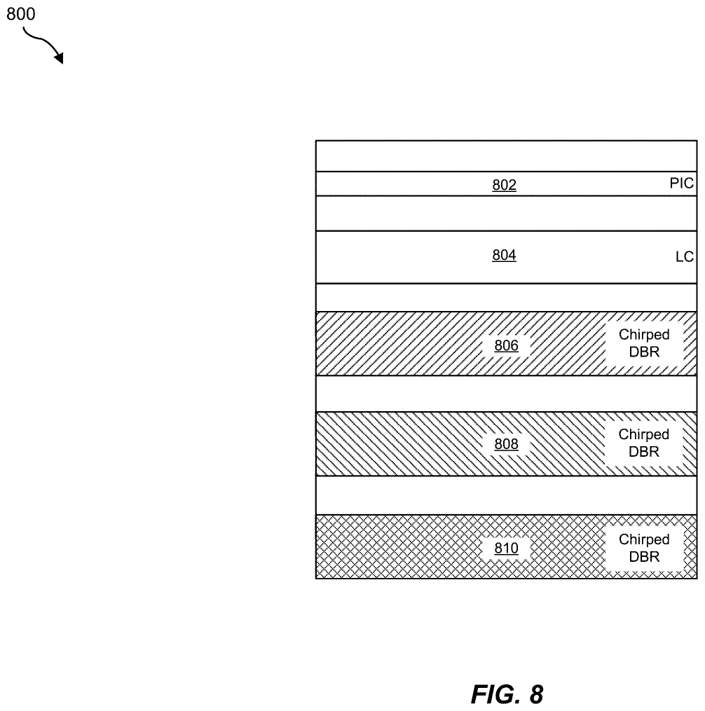

FIG. 8 illustrates an example illumination system 800 with chirped distributed Bragg reflectors separately interacting with red, green, and blue light. As shown in FIG. 8, illumination system 800 may include a photonic integrated circuit 802, a liquid crystal 804, a chirped distributed Bragg reflector 806 for blue light, a chirped distributed Bragg reflector 808 for green light, and a chirped distributed Bragg reflector 810 for red light. Chirped distributed Bragg reflectors 806, 808, and 810 may be placed at different layers for blue, green, and red light, respectively, and/or may be engineered to reflect blue, green, and red light, respectively.

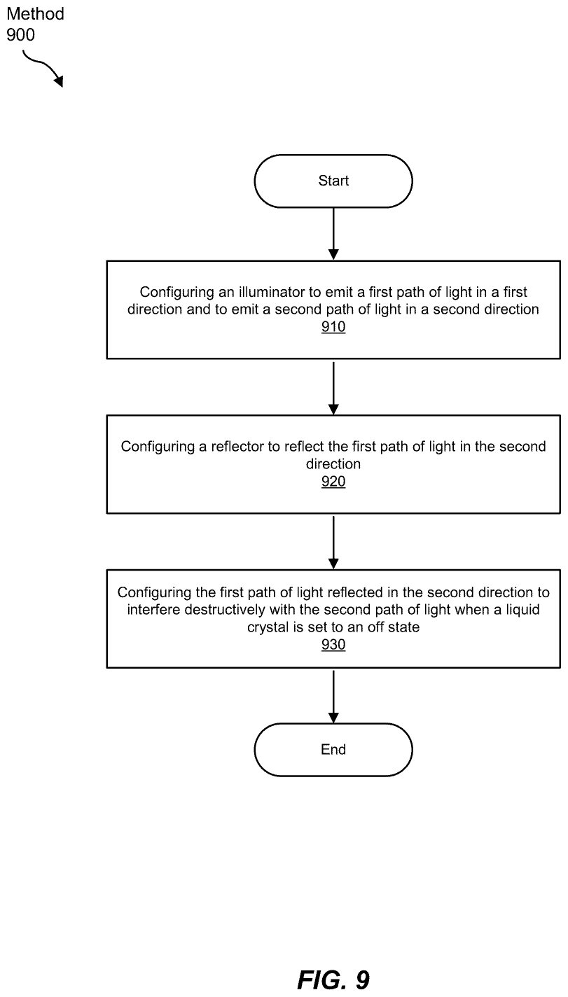

FIG. 9 illustrates an example method 900 for configuring a laser-illuminated display as described above with reference to FIGS. 1-8. As shown in FIG. 9, method 900 may, at step 910, include configuring an illuminator. For example, method 900 may, at step 910, include configuring an illuminator to emit a first path of light in a first direction and to emit a second path of light in a second direction.

The term “liquid crystal,” as used herein, may generally refer to a state of matter. For example, and without limitation, a liquid crystal (LC) may correspond to a state of matter having properties that are between those of conventional liquids and those of solid crystals. In this context, a liquid crystal can flow like a liquid, but its molecules may be oriented in a common direction as in a solid. There are many types of LC phases, which can be distinguished by their optical properties (e.g., textures). The contrasting textures may arise due to molecules within one area of material (e.g., a “domain”) being oriented in the same direction but different areas having different orientations. An LC material may not always be in an LC state of matter (just as water may be ice or water vapor). Types of liquid crystals may include, without limitation, thermotropic, lyotropic, and/or metallotropic types. Thermotropic and lyotropic liquid crystals may include mostly organic molecules, although a few minerals are also known. Thermotropic LCs may exhibit a phase transition into the LC phase as temperature changes. Lyotropic LCs may exhibit phase transitions as a function of both temperature and concentration of molecules in a solvent (e.g., typically water). Metallotropic LCs may be composed of both organic and inorganic molecules and their LC transition may additionally depend on the inorganic-organic composition ratio.

The term “silicon display,” as used herein, may generally refer to a liquid crystal on a silicon backplane. For example, and without limitation, a silicon display may correspond to a miniature reflective active-matrix liquid crystal display (e.g., a microdisplay, a spatial light modulator, etc.) using a liquid crystal on silicon backplane. Silicon displays may be used for projection televisions, wavelength selective switching, structured illumination, near-eye displays, optical pulse shaping, etc.

The term “illuminator,” as used herein, may generally refer to an illumination unit. For example, and without limitation, an illuminator may correspond to an optical element (e.g., a photonic integrated circuit) that directs and distributes laser light onto a display panel.

The term “path of light,” as used herein, may generally refer to a path in an optical medium. For example, and without limitation, a path of light may correspond to a path traveled in an optical medium (e.g., silicon, liquid crystal, cladding, etc.) by a beam of light (e.g., laser light) propagating in the optical medium. In this context, the path may be determined by light beam emission directions, angles of reflection, waveguides, etc.

Method 900 may perform step 910 in various ways. For example, method 900 may, at step 910, include configuring the illuminator to emit the second path of light in the second direction that is opposite the first direction. For example, the second direction may be a direction towards a polarizer of a display panel. Alternatively or additionally, method 900 may, at step 910, include configuring the illuminator to emit the first path of light in the first direction towards a reflector. In this context, method 900 may, at step 910, include configuring the illuminator to emit the first path of light in the first direction through a liquid crystal and towards the reflector. In this context, method 900 may, at step 910, include configuring the illuminator to emit the first path of light in the first direction through cladding positioned between the illuminator and the liquid crystal. In some implementations, method 900 may, at step 910, include configuring an illuminator that includes a photonic integrated circuit.

The term “polarizer,” as used herein, may generally refer to an optical filter. For example, and without limitation, a polarizer may correspond to an optical filter that may filter a beam of light of undefined or mixed polarization into a beam of well-defined polarization known as polarized light. Types of polarizers can include linear polarizers and circular polarizes. Polarizers can be made for visible light and other types of electromagnetic waves, such as radio waves, microwaves, and X-rays. Polarizers may find applications in photography and LCD technology, such as liquid crystal on silicon displays.

The term “reflector,” as used herein, may generally refer to a device that causes reflection. For example, and without limitation, a reflector may correspond to a mirror, a retroreflector, a meta-reflector, a distributed Bragg reflector, etc.

The term “cladding,” as used herein, may generally refer to a layer of material. For example, and without limitation, cladding may correspond to a layer of material applied over another layer of material to provide a skin or layer. In this context, cladding may be used to protect a layer over which it is applied, to provide thermal insulation, to provide spacing between layers of material, etc.

The term “photonic integrated circuit,” as used herein, may generally refer to a microchip. For example, and without limitation, a photonic integrated circuit may correspond to a microchip containing two or more photonic components that form a functioning circuit. This technology may detect, generate, transport, and/or process light.

As shown in FIG. 9, method 900 may, at step 920, include configuring a reflector. For example, method 900 may, at step 920, include configuring a reflector to reflect the first path of light in the second direction.

Method 900 may perform step 920 in various ways. For example, method 900 may, at step 920, include configuring a reflector that includes a mirror. Alternatively or additionally, method 900 may, at step 920, include configuring a reflector that includes a meta-reflector having anomalous dispersion. Alternatively or additionally, method 900 may, at step 920, include configuring a reflector that includes a chirped distributed Bragg reflector having a spatially varying pitch.

The term “meta-reflector,” as used herein, may generally refer to an array of structures. For example, and without limitation, a meta-reflector may correspond to an array of structures (e.g., subwavelength nanostructures) arranged in a periodic configuration. In this context, the array of structures can be configured to affect properties (e.g., phase, amplitude, etc.) of light reflected by the structures. In some implementations, the array of structures may be positioned atop a reflector. Without limitation, the structures can have various types of shapes, such as cubic, square, rectangular, cylindrical, L-shaped, circular, semicircular, etc.

The term “anomalous dispersion,” as used herein, may generally refer to a reversal of color. For example, and without limitation, anomalous dispersion may correspond to reversal of colors of light seen at different wavelengths. In this context, anomalous dispersion may correspond to dispersion of light in refraction spectra in which a normal order of separation of components is reversed in a vicinity of certain wavelengths of light. In an example, an optical medium may exhibit anomalous dispersion when refraction indices increase with increasing wavelength.

The term “chirped distributed Bragg reflector,” as used herein, may generally refer to a structure formed of multiple layers. For example, and without limitation, a chirped distributed Bragg reflector may correspond to a structure formed from multiple layers of alternating materials with different refractive index, or by periodic variation of some characteristic (e.g., height) of a dielectric waveguide, resulting in periodic variation in the effective refractive index in the guide. In this context, each layer boundary may cause a partial reflection and refraction of an optical wave. For waves whose vacuum wavelength is close to four times the optical thickness of the layers, the interaction between these beams may generate constructive interference, and the layers may act as a high-quality reflector. In this context, a chirp may correspond to a variation in a grating period along a grating length to achieve higher bandwidths or to obtain spectra that exhibit a linear group delay.

The term “spatially varying pitch,” as used herein, may generally refer to non-uniform spacing of layers. For example, and without limitation, a spatially varying pitch may correspond to non-uniform spacing of layers (e.g., continuous variation, discontinuous variation, etc.) in a distributed Bragg reflector.

As shown in FIG. 9, method 900 may, at step 930, include configuring the first path of light. For example, method 900 may, at step 920, include configuring the first path of light reflected in the second direction to interfere destructively with the second path of light when the liquid crystal is set to an off state.

The term “interfere destructively,” as used herein, may generally refer to cancellation by one another of two waves of light. For example, and without limitation, interfere destructively may correspond to partial or complete cancellation of one wave of light by another wave of light when crests and troughs of the two waves of light meet. In this context, two waves of light may have a same wavelength and crests of one of the waves may align with troughs of the other one of the waves. If amplitudes of the waves are equal, then the waves may cancel one another completely. Otherwise, a wave of greater amplitude may be partially cancelled by a wave of lesser amplitude, resulting in partial cancellation.

The term “off state,” as used herein, may generally refer to a state of a liquid crystal. For example, and without limitation, an off state may correspond to a state of liquid crystal in which no polarization conversion is performed. In contrast, ninety-degree polarization conversion may be performed in an “on state” of the liquid crystal.

Method 900 may perform step 930 in various ways. For example, method 900 may, at step 930, include positioning cladding between the illuminator and the liquid crystal. For example, the cladding may have a thickness configured to cause the first path of light reflected in the second direction to interfere destructively with the second path of light when the liquid crystal is set to the off state. Alternatively or additionally, method 900 may, at step 930, include configuring the liquid crystal. For example, the liquid crystal may be configured with an index that causes the first path of light reflected in the second direction to interfere destructively with the second path of light when the liquid crystal is set to the off state. Alternatively or additionally, method 900 may, at step 930, include configuring the reflector. For example, the reflector may be configured with a phase dispersion of the reflector that causes the first path of light reflected in the second direction to interfere destructively with the second path of light when the liquid crystal is set to the off state. In this context, method 900 may, at step 930, configure a reflector that includes a meta-reflector having anomalous dispersion. Alternatively or additionally, method 900 may, at step 930, include configuring a reflector that includes a chirped distributed Bragg reflector having a spatially varying pitch. In this context, method 900 may, at step 930, include configuring the spatially varying pitch of the chirped distributed Bragg reflector to maintain destructive interference across a spectral bandwidth by tuning one or more effective optical path lengths for different wavelengths of light.

Method 900 may perform step 930 using any of the techniques described herein, either alone or in combination, to cause the first path of light reflected in the second direction to interfere destructively with the second path of light when the liquid crystal is set to an off state. For example, method 900 may, at step 930, engineer the cladding thickness, the liquid crystal index, and/or the reflector to control interference between the first path and the second path such that ϕ_{off}=(2n+1)π, where ϕ_{off} refers to a phase shift of a light beam when the liquid crystal is set to an off state and n refers to an integer. For example, effective optical path lengths can be controlled by cladding thickness, liquid crystal index, by anomalous dispersion, by spacing between layers in a chirped distributed Bragg grating, or combinations thereof.

The term “index,” as used herein, may generally refer to a refractive index. For example, and without limitation, an index may correspond to a refractive index of a liquid crystal. In this context, a refractive index may correspond to a dimensionless number that indicates a light bending ability of an optical medium, such as a liquid crystal.

The term “spectral bandwidth,” as used herein, may generally refer to a range of wavelengths or frequencies. For example, and without limitation, a spectral bandwidth may correspond to a range of wavelengths or frequencies over which a magnitude of all spectral components is equal to or greater than a specified fraction of a largest magnitude.

The term “effective optical path length,” as used herein, may generally refer to a length traveled by light. For example, and without limitation, an effective optical path length may correspond to a length that light needs to travel in a vacuum to create a same phase difference as it would have when travelling through a given medium. In this context, an effective optical path length may correspond to an average distance that light travels in an optical medium.

The term “wavelength of light,” as used herein, may generally refer to a distance between components of a light wave. For example, and without limitation, a wavelength of light may correspond to a distance between two successive crests or troughs of a light wave.

As set forth above, the disclosed systems and methods can achieve a high-contrast laser-illuminated display. For example, by configuring an illuminator to emit a first path of light in a first direction and to emit a second path of light in a second direction, configuring a reflector to reflect the first path of light in the second direction, and configuring the first path of light reflected in the second direction to interfere destructively with the second path of light when a liquid crystal is set to an off state, contrast ratio of a laser-illuminated display can be improved.

### Example Embodiments

Example 1: A display device may include a liquid crystal, an illuminator configured to emit a first path of light in a first direction and to emit a second path of light in a second direction, and a reflector configured to reflect the first path of light in the second direction, wherein the first path of light reflected in the second direction is configured to interfere destructively with the second path of light when the liquid crystal is set to an off state.

Example 2: The display device of Example 1, further including cladding positioned between the illuminator and the liquid crystal and having a thickness configured to cause the first path of light reflected in the second direction to interfere destructively with the second path of light when the liquid crystal is set to the off state.

Example 3: The display device of any of Examples 1 or 2, further including a liquid crystal having an index configured to cause the first path of light reflected in the second direction to interfere destructively with the second path of light when the liquid crystal is set to the off state.

Example 4: The display device of any of Examples 1 to 3, wherein a phase dispersion of the reflector is configured to cause the first path of light reflected in the second direction to interfere destructively with the second path of light when the liquid crystal is set to the off state.

Example 5: The display device of any of Examples 1 to 4, wherein the reflector includes a meta-reflector having anomalous dispersion.

Example 6: The display device of any of Examples 1 to 5, wherein the reflector includes a chirped distributed Bragg reflector having a spatially varying pitch.

Example 7: The display device of any of Examples 1 to 6, wherein the spatially varying pitch of the chirped distributed Bragg reflector is configured to maintain destructive interference across a spectral bandwidth by tuning one or more effective optical path lengths for different wavelengths of light.

Example 8: A system may include a photonic integrated circuit configured to emit a first path of light in a first direction and to emit a second path of light in a second direction opposite the first direction and a reflector configured to reflect the first path of light in the second direction with a phase dispersion that causes the first path of light reflected in the second direction to interfere destructively with the second path of light emitted in the second direction.

Example 9: The system of Example 8, further including a liquid crystal, wherein the phase dispersion causes the first path of light reflected in the second direction to interfere destructively with the second path of light emitted in the second direction when the liquid crystal is set to an off state.

Example 10: The system of any of Examples 8 or 9, further including cladding positioned between the photonic integrated circuit and a liquid crystal and having a thickness configured to cause the first path of light reflected in the second direction to interfere destructively with the second path of light when the liquid crystal is set to an off state.

Example 11: The system of any of Examples 8 to 10, further including a liquid crystal having an index configured to cause the first path of light reflected in the second direction to interfere destructively with the second path of light when the liquid crystal is set to an off state.

Example 12: The system of any of Examples 8 to 11, wherein the reflector includes at least one of a meta-reflector having anomalous dispersion or a chirped distributed Bragg reflector having a spatially varying pitch.

Example 13: The system of any of Examples 8 to 12, wherein the reflector includes the chirped distributed Bragg reflector and the spatially varying pitch of the chirped distributed Bragg reflector is configured to maintain destructive interference across a spectral bandwidth by tuning one or more effective optical path lengths for different wavelengths of light.

Example 14: A method may include, comprising configuring an illuminator to emit a first path of light in a first direction and to emit a second path of light in a second direction, configuring a reflector to reflect the first path of light in the second direction, and configuring the first path of light reflected in the second direction to interfere destructively with the second path of light when the liquid crystal is set to an off state.

Example 15: The method of Example 14, further including positioning cladding between the illuminator and the liquid crystal, wherein the cladding has a thickness configured to cause the first path of light reflected in the second direction to interfere destructively with the second path of light when the liquid crystal is set to the off state.

Example 16: The method of any of Examples 14 or 15, further including configuring the liquid crystal with an index that causes the first path of light reflected in the second direction to interfere destructively with the second path of light when the liquid crystal is set to the off state.

Example 17: The method of any of Examples 14 to 16, further including configuring a phase dispersion of the reflector to cause the first path of light reflected in the second direction to interfere destructively with the second path of light when the liquid crystal is set to the off state.

Example 18: The method of any of Examples 14 to 17, wherein the reflector includes a meta-reflector having anomalous dispersion.

Example 19: The method of any of Examples 14 to 18, wherein the reflector includes a chirped distributed Bragg reflector having a spatially varying pitch.

Example 20: The method of any of Examples 14 to 19, configuring the spatially varying pitch of the chirped distributed Bragg reflector to maintain destructive interference across a spectral bandwidth by tuning one or more effective optical path lengths for different wavelengths of light.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

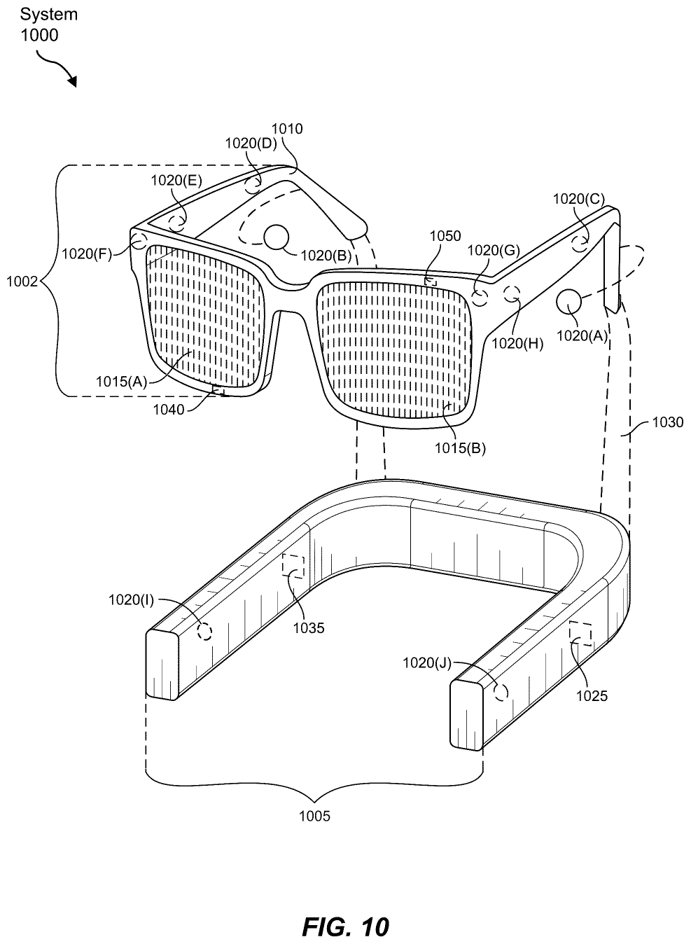

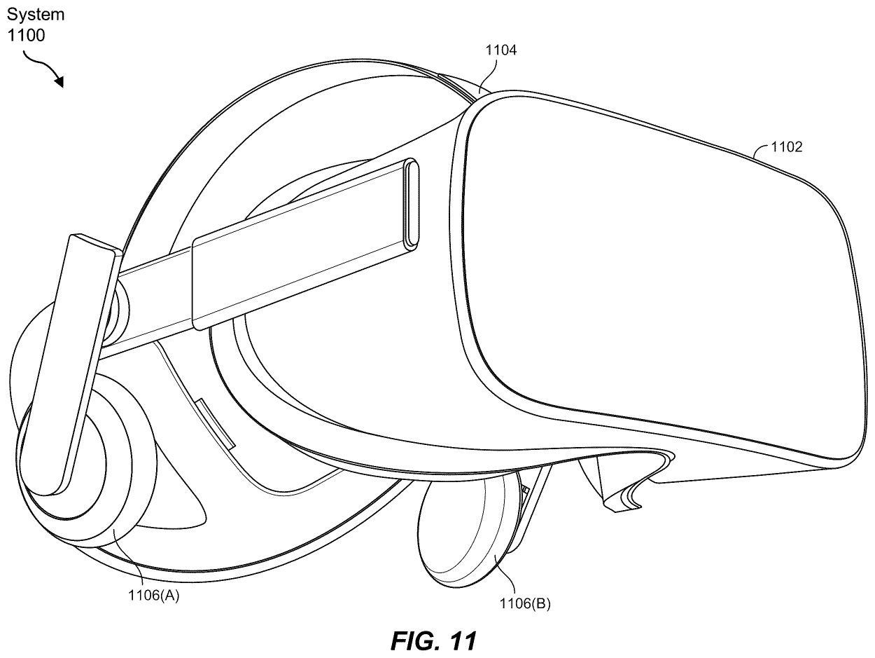

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality system 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A display device, comprising:
a liquid crystal;
an illuminator configured to emit a first path of light in a first direction and to emit a second path of light in a second direction; and
a reflector configured to reflect the first path of light in the second direction, wherein the first path of light reflected in the second direction is configured to interfere destructively with the second path of light when the liquid crystal is set to an off state.

2. The display device of claim 1, further comprising:
cladding positioned between the illuminator and the liquid crystal and having a thickness configured to cause the first path of light reflected in the second direction to interfere destructively with the second path of light when the liquid crystal is set to the off state.

3. The display device of claim 1, further comprising:
a liquid crystal having an index configured to cause the first path of light reflected in the second direction to interfere destructively with the second path of light when the liquid crystal is set to the off state.

4. The display device of claim 1, wherein a phase dispersion of the reflector is configured to cause the first path of light reflected in the second direction to interfere destructively with the second path of light when the liquid crystal is set to the off state.

5. The display device of claim 4, wherein the reflector includes a meta-reflector having anomalous dispersion.

6. The display device of claim 4, wherein the reflector includes a chirped distributed Bragg reflector having a spatially varying pitch.

7. The display device of claim 6, wherein the spatially varying pitch of the chirped distributed Bragg reflector is configured to maintain destructive interference across a spectral bandwidth by tuning one or more effective optical path lengths for different wavelengths of light.

8. A system comprising:
a photonic integrated circuit configured to emit a first path of light in a first direction and to emit a second path of light in a second direction opposite the first direction; and
a reflector configured to reflect the first path of light in the second direction with a phase dispersion that causes the first path of light reflected in the second direction to interfere destructively with the second path of light emitted in the second direction.

9. The system of claim 8, further comprising:
a liquid crystal,
wherein the phase dispersion causes the first path of light reflected in the second direction to interfere destructively with the second path of light emitted in the second direction when the liquid crystal is set to an off state.

10. The system of claim 8, further comprising:
cladding positioned between the photonic integrated circuit and a liquid crystal and having a thickness configured to cause the first path of light reflected in the second direction to interfere destructively with the second path of light when the liquid crystal is set to an off state.

11. The system of claim 8, further comprising:
a liquid crystal having an index configured to cause the first path of light reflected in the second direction to interfere destructively with the second path of light when the liquid crystal is set to an off state.

12. The system of claim 8, wherein the reflector includes at least one of:
a meta-reflector having anomalous dispersion; or
a chirped distributed Bragg reflector having a spatially varying pitch.

13. The system of claim 12, wherein the reflector includes the chirped distributed Bragg reflector and the spatially varying pitch of the chirped distributed Bragg reflector is configured to maintain destructive interference across a spectral bandwidth by tuning one or more effective optical path lengths for different wavelengths of light.

14. A method, comprising:
configuring an illuminator to emit a first path of light in a first direction and to emit a second path of light in a second direction;
configuring a reflector to reflect the first path of light in the second direction; and
configuring the first path of light reflected in the second direction to interfere destructively with the second path of light when a liquid crystal is set to an off state.

15. The method of claim 14, further comprising:
positioning cladding between the illuminator and the liquid crystal, wherein the cladding has a thickness configured to cause the first path of light reflected in the second direction to interfere destructively with the second path of light when the liquid crystal is set to the off state.

16. The method of claim 14, further comprising:
configuring the liquid crystal with an index that causes the first path of light reflected in the second direction to interfere destructively with the second path of light when the liquid crystal is set to the off state.

17. The method of claim 14, further comprising:
configuring a phase dispersion of the reflector to cause the first path of light reflected in the second direction to interfere destructively with the second path of light when the liquid crystal is set to the off state.

18. The method of claim 17, wherein the reflector includes a meta-reflector having anomalous dispersion.

19. The method of claim 17, wherein the reflector includes a chirped distributed Bragg reflector having a spatially varying pitch.

20. The method of claim 19, further comprising:
configuring the spatially varying pitch of the chirped distributed Bragg reflector to maintain destructive interference across a spectral bandwidth by tuning one or more effective optical path lengths for different wavelengths of light.
